(19) United States
(12) Patent Application Publication
(10) Pub. No.: US 2011/0268296 A1
(43) Pub. Date: Nov. 3, 2011

(54) CONDENSER MICROPHONE ASSEMBLY WITH FLOATING CONFIGURATION

(75) Inventor: Chung-Dam Song, Seoul (KR)

(73) Assignee: BSE CO., LTD., Incheon (KR)

(21) Appl. No.: 13/143,581

(22) PCT Filed: Feb. 11, 2010
(86) PCT No.: PCT/KR10/00871

§ 371 Date: Jul. 7, 2011

(30) Foreign Application Priority Data
Oct. 14, 2009 (KR) 10-2009-0097676

(51) Int. Cl. H04R 19/04

(52) U.S. Cl. 381/174

(57) ABSTRACT

A condenser microphone assembly without electrets formed on a rear pole plate, and having an electrically floating diaphragm and improved capacitance. The condenser microphone assembly includes a sounding body in which a floating bias voltage is applied between a diaphragm and a rear pole plate facing one another and electrically separated by a small space therebetween, where capacitance changes when the diaphragm vibrates according to sound pressure from an external sound source; a printed circuit board (PCB) assay having an output terminal and ground terminal formed on an outer surface thereof, connected to an external circuit through the output terminal and ground terminal, having a buffer integrated circuit (IC) mounted on an inner surface thereof to boost an input voltage applied to a voltage pump built into the buffer IC, applying an electrically floating bias voltage to the sounding body, and outputting an amplified electric signal by the buffer IC, of a change in capacitance of the sounding body, through the output terminal and ground terminal; and a cylindrical case of metal material with one open surface, coated with an insulation material on the inside thereof except for around the end of the open surface, electrically insulated from the sounding body, including the sounding body within a compartment thereof, curling-coupled to the PCB assay, and coupled to the ground terminal to electrically shield the sounding body

### TECHNICAL FIELD

The present invention relates to a condenser microphone, and more particularly, to a condenser microphone assembly without electrets formed on a rear pole plate, and having an electrically floating diaphragm and improved capacitance.

### BACKGROUND ART

Although an electret condenser microphone requiring no bias power has been widely used as a small condenser microphone in mobile terminals, due to demands for applications of surface mounting technology (SMT), a condenser microphone having various structures for surface mounting devices (SMD) has been developed for addressing the thermal vulnerability of electrets. Particularly, along with the developments of technologies for semiconductor chip fabrication, a buffer integrated circuit (IC) having built therein a voltage pump which generates a high bias voltage by boosting a low direct current (DC) voltage has been developed, thereby enabling the application of a bias structure to a condenser microphone for SMD.

Meanwhile, it is difficult to form electrets on a micro-electro mechanical system (MEMS) microphone chip in a silicon condenser microphone used for mobile devices, and thus, a silicon condenser microphone operates in bias mode by using a buffer IC having built therein a voltage pump. To operate in bias mode, the MEMS floating chip is electrically floated, wherein a capacitance of the MEMS floating chip is generally around 1 pF.

However, in a case where a capacitance of a condenser microphone is as small as around 1 pF, it is difficult to obtain high sensitivity characteristics and low sensitivity characteristics in a buffer IC.

### DISCLOSURE OF THE INVENTION

### Technical Problem

The present invention provides a condenser microphone having a large capacitance and an electrically floated structure.

The present invention also provides a condenser microphone for surface mounting devices (SMD), which operate in bias mode by using a buffer integrated circuit (IC) having built therein a voltage pump.

### Technical Solution

According to an aspect of the present invention, there is provided a condenser microphone assembly with a floating configuration including a sounding body in which a floating bias voltage is applied between a diaphragm and a rear pole plate facing one another and electrically separated by a small space therebetween, where capacitance changes when the diaphragm vibrates according to sound pressure from an external sound source; a printed circuit board (PCB) assay having an output terminal and ground terminal formed on an outer surface thereof, connected to an external circuit through the output terminal and ground terminal, having a buffer integrated circuit (IC) mounted on an inner surface thereof to boost an input voltage applied to a voltage pump built into the buffer IC, applying an electrically floating bias voltage to the sounding body, and output an amplified electric signal by the buffer IC, of a change in capacitance of the sounding body, through the output terminal and ground terminal; and a cylindrical case of metal material with one open surface, coated with an insulation material on the inside thereof except for around the end of the open surface, electrically insulated from the sounding body, including the sounding body within a compartment thereof, curling-coupled to the PCB assay, and coupled to the ground terminal to electrically shield the sounding body

The sounding body includes a diaphragm mounted on thing according to an external sound source; an insulation base, which has a conductive pattern formed on an insulating body, applies a bias voltage of a predetermined polarity to the diaphragm, electrically insulates the diaphragm from the bias voltage having an opposite polarity, and supports internal components of the condenser microphone assembly during a curling operation; a spacer that is made of a insulation material, is mounted inside the insulation base, and forms fine spaces; a rear pole plate, which faces the diaphragm, wherein the spacer is disposed between the rear pole plate and the diaphragm; and a conductive base for applying the bias voltage having the other polarity to the rear pole plate.

### ADVANTAGEOUS EFFECTS

Since a condenser microphone according to the present invention does not employ electrets, the performance of the condenser microphone does not deteriorate after a high-temperature reflow operation, and thus, the condenser microphone may constantly have high quality. Furthermore, the condenser microphone has a capacitance larger than that of a MEMS microphone chip, and thus, the condenser microphone may have low noise and high performance.

### BRIEF DESCRIPTION OF THE DRAWINGS

to FIG. 1 is a schematic diagram of condenser microphones according to an embodiment of the present invention;

FIG. 2 is a cross-sectional view of a condenser microphone assembly according of an embodiment of the present invention;

FIG. 3 is a perspective view of the condenser microphone assembly according of an embodiment of the present invention;

FIG. 4 is a diagram showing a diaphragm of a condenser microphone assembly according to an embodiment of the present invention;

FIG. 5 is a diagram showing an insulation base of a condenser microphone according to an embodiment of the present invention; and

FIG. 6 is a diagram showing an example of a rear pole plate having built therein a spacer in a condenser microphone according to an embodiment of the present invention.

### BEST MODE FOR CARRYING OUT THE INVENTION

The present invention will now be described more fully with reference to the accompanying drawings, in which exemplary embodiments of the invention are shown. The invention may, however, be embodied in many different forms and should not be construed as being limited to the embodiments set forth herein.

FIG. 1 is a schematic diagram of a condenser microphone 100 according to an embodiment of the present invention.

As shown in FIG. 1, the condenser microphone 100 according to the present embodiment includes a sounding body 10 of which capacitance changes when a floating bias voltage is applied thereto and a diaphragm vibrates according to sound pressure applied from an external sound source, a buffer integrated circuit (IC) 20 which is connected to an external circuit via an output terminal Vout and a ground terminal GND, boosts an input voltage applied to a voltage pump built into the buffer IC 20, applies an electrically floating bias voltage to the sounding body 10, amplifies a change in the capacitance of the sounding body 10 to an electric signal, and outputs the amplified electric signal through the output terminal Vout and the ground terminal GND, and a case 102 which is connected to the ground terminal GND and electrically shields the sounding body 10.

Referring to FIG. 1, the buffer IC 20 includes a voltage pump which generates a floating bias voltage by boosting a direct current (DC) voltage input via the output terminal Vout and the ground terminal GND to a high voltage and an amplifier which amplifies a change in capacitance of the sounding body 10 to an electric signal and outputs the amplified electric signal through the output terminal Vout and the ground terminal GND.

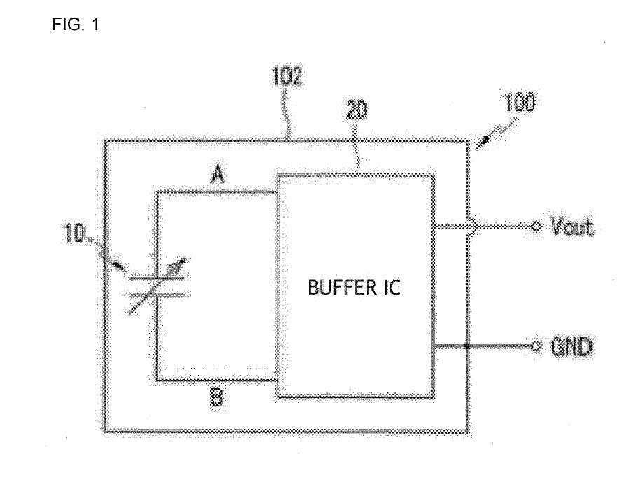

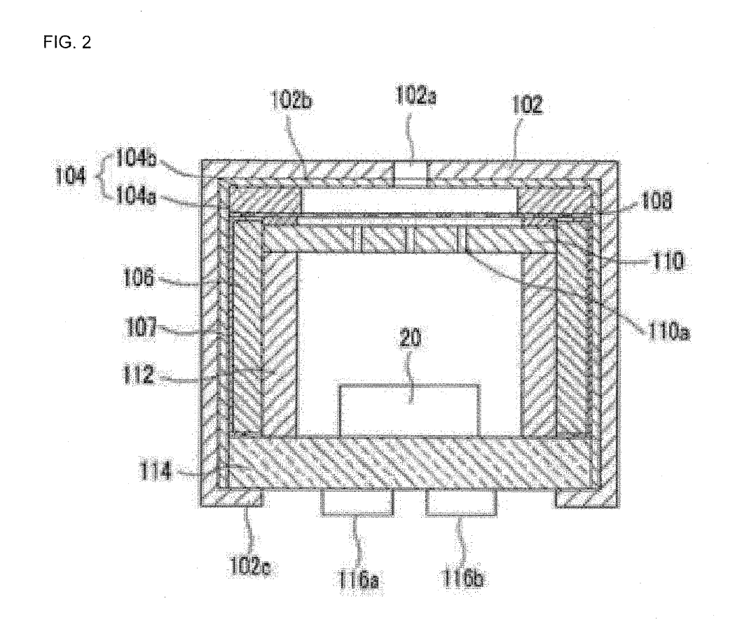

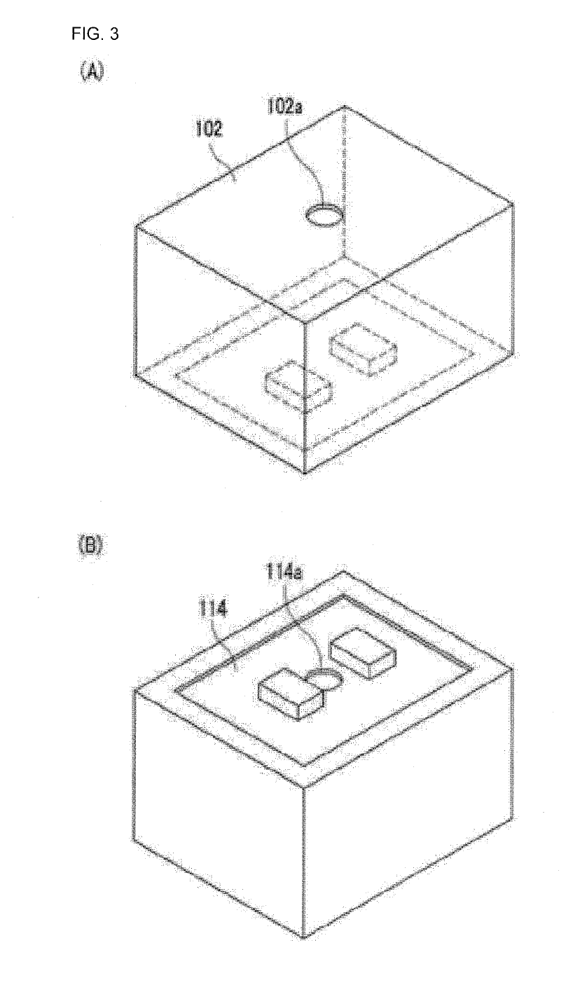

FIG. 2 is a cross-sectional view of a condenser microphone assembly 100 according of an embodiment of the present invention. FIG. 3 is a perspective view of the condenser microphone assembly 100 of FIG. 3.

As shown in FIG. 2, the condenser microphone assembly 100 according to the present embodiment includes a cuboidal case 102 made of a metal material and coated with an insulation material on the inside thereof, a diaphragm 104 mounted on the bottom surface of the case 102 and vibrating according to an external sound source, an insulation base 106, which has a conductive pattern 107 formed on an insulative body, applies a bias voltage of a predetermined polarity to the diaphragm 104, electrically insulates the diaphragm 104 from a bias voltage having an opposite polarity, and supports internal components of the condenser microphone assembly 100 during a curling operation, a spacer 108 made of an insulation material and mounted inside the insulation base 106, a rear pole plate 110 which faces the diaphragm 104, wherein the spacer 108 is disposed between the rear pole plate 110 and the diaphragm 104, a conductive base 112 for applying the bias voltage having the opposite polarity to the rear pole plate 110, the buffer IC 20 which is connected to an external circuit via an output terminal Vout 116a and a ground terminal GND 116b, boosts an input voltage applied to a voltage pump built into the buffer IC, applies an electrically floating bias voltage to the sounding body 10, amplifies a change in capacitance of the sounding body 10 to an electric signal, and outputs the amplified electric signal through the output terminal Vout 116a and ground terminal GND 116b, and a printed circuit board (PCB) assay 114 which has the output terminal Vout 116a and the ground terminal GND 116b formed on an outer surface thereof, has the buffer IC 20 mounted on an inner surface thereof, applies a floating bias voltage that has a predetermined polarity and is floated by the conductive pattern 107 of the insulation base 106 to the diaphragm 104, applies the floating bias voltage having an opposite polarity to the rear pole plate 110 via the conductive base 112, and forms an assembly by being closely attached to an end of the case 102 during a curling operation.

Referring to FIG. 2, the case 102 is a cuboid with one open surface, and the inside of the case 102 is coated with an insulation material 102b except for around ends of the open side. An end 102c of the open surface that is not coated with the insulation material 102b is electrically connected to a ground pattern formed on the PCB assay 114, so that noise is reduced by electrically shielding devices inside the case 102. Furthermore, a sound hole 102a may be formed in the bottom surface of the case 102.

The rear pole plate 110 is a metal plate without electrets, and a sound hole 110a is formed in the rear pole plate 110 for smooth vibration of the diaphragm 104.

The buffer IC 20 is mounted on an inner surface of the PCB assay 114. The connection terminals 116a and 116b are formed on an outer surface of the PCB assay 114. Although not shown, a ground pattern is formed on a surface of the PCB assay 114 to be connected to the end 102c of the case 102, whereas patterns for connection with the buffer IC 20 are formed on a surface of the PCB assay 114 to be connected to the conductive pattern 107 of the insulation base 106 and a surface of the PCB assay 114 to be connected to the conductive base 112.

The condenser microphone assembly 100 according to the present embodiment as described above requires a sound hole for introducing external sound as shown in FIG. 3. In FIG. 3, (A) shows a case in which the sound hole 102a is formed in the case 102, whereas (B) shows a case in which a sound hole 114a is formed in the PCB assay 114.

Referring to FIG. 3, the condenser microphone assembly has a cuboidal shape and is completed by mounting the diaphragm 104, the insulation base 106, the spacer 108, the rear pole plate 110, the conductive base 112, and the PCB assay 114 in a space inside the case 102 and curling the end 102c of the case 102. Furthermore, such the condenser microphone assembly 100 is mounted to an electronic device by using a surface mounting technology (SMT), generates a bias voltage by receiving input of DC power from a mainboard via the connection terminals 116a and 116b, operates according to the bias voltage, and outputs an audio signal according to an external sound source via the connection terminals 116a and 116b.

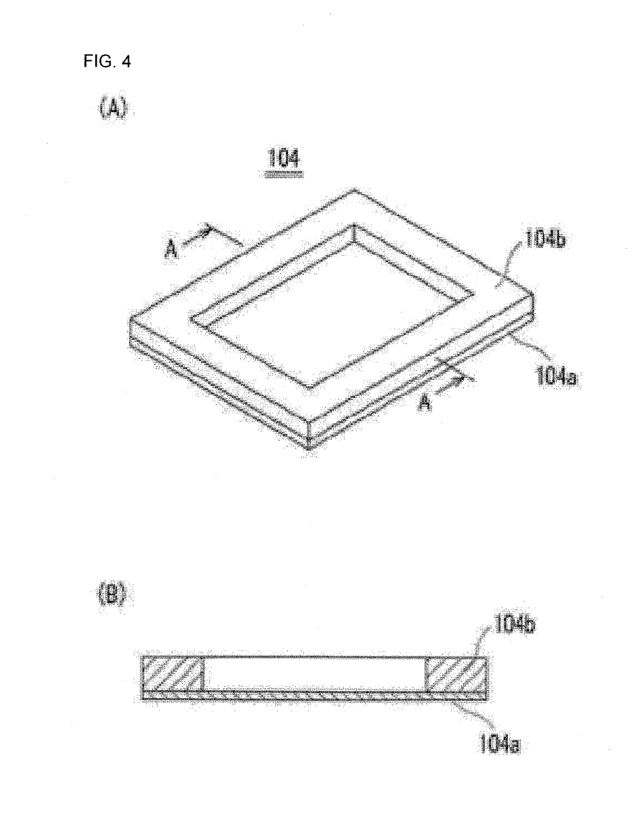

FIG. 4 is a diagram showing a diaphragm 104 of a condenser microphone assembly according to an embodiment of the present invention, where (A) is a schematic perspective view of the diaphragm, and (B) is a cross-sectional view obtained along a line A-A.

As shown in FIG. 4, the diaphragm 104 of the condenser microphone assembly according to the present embodiment includes a diaphragm 104a which vibrates according to an external sound source and a polar ring 104b which supports the diaphragm 104a for smooth vibration. Furthermore, although not shown in detail, the diaphragm 104a may be fabricated by coating a thin-film (PPS film) with gold (Au).

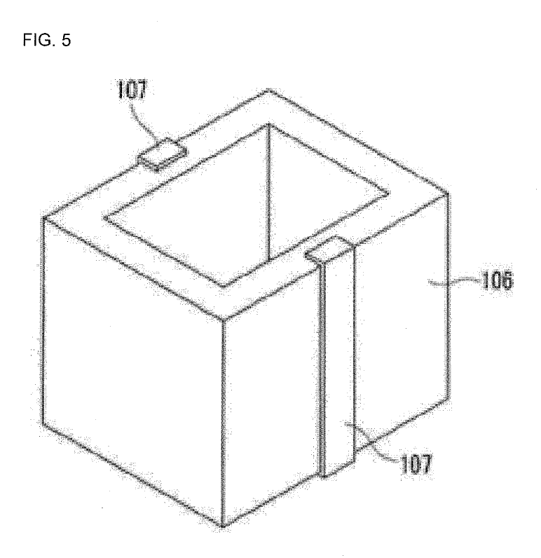

FIG. 5 is a diagram showing an insulation base 106 of a condenser microphone according to an embodiment of the present invention.

As shown in FIG. 5, the insulation base 106 of the condenser microphone according to the present embodiment has the conductive pattern 107 formed on an insulating body, thus enabling application of a bias voltage to the diaphragm 104 and maintenance of insulation of the diaphragm 104 from the conductive base 112 inserted inside the insulation base 106. Here, an end of the conductive pattern 107 is cut, and thus, the conductive pattern 107 does not contact the conductive base 112 inserted inside the insulation base 106.

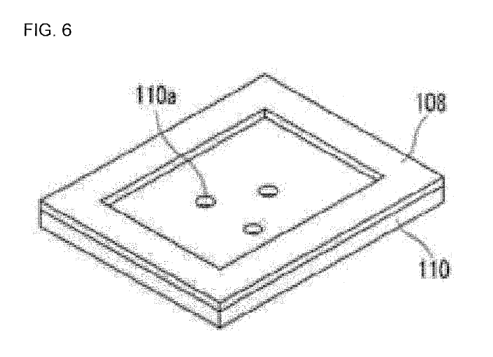

FIG. 6 is a diagram showing an example of a rear pole plate having built therein a spacer in a condenser microphone according to an embodiment of the present invention.

As shown in FIG. 6, in the rear pole plate 110 of the condenser microphone according to the present embodiment, a spacer 108 of insulation material is attached to a surface of the rear pole plate 110 of metal material for easy assembly. The sound hole 110a is formed in the rear pole plate 110 of metal material for smooth vibration of the diaphragm 104, and the spacer 108 is formed on the rear pole plate 110 by laminating or coating the rear pole plate 110 with an insulation material or laminating or coating the rear pole plate 110 with an insulation material after forging the rear pole plate 110.

Operation of the condenser microphone according to the present embodiment that is configured as described above will be described below.

As shown in FIG. 2, in the condenser microphone assembly 100 according to the present embodiment, the diaphragm 104 is connected to the buffer IC 20 mounted on the PCB assay 114 via the conductive pattern 107 of the insulation base 106, and the rear pole plate 110 is connected to the buffer IC 20 mounted on the PCB assay 114 via the conductive base 112, and thus, a bias voltage is applied between the diaphragm 104 and the rear pole plate 110. As a result, a capacitance larger than that of a micro-electro mechanical system (MEMS) microphone is formed between the diaphragm 104 and the rear pole plate 110.

In this state, when a sound of a predetermined pressure from an external sound source is introduced via the sound hole 102a, the diaphragm 104 vibrates, and thus, the capacitance formed between the diaphragm 104 and the rear pole plate 110 changes. The change in the capacitance is amplified to an electric signal by an amplifier of the buffer IC, and the amplified electric signal is output to an external circuit via the connection terminals 116a and 116b.

Therefore, since the condenser microphone according to the present invention does not employ electrets, the performance of the condenser microphone does not deteriorate after a high-temperature reflow operation, and thus, the condenser microphone may constantly have high quality. Furthermore, the condenser microphone has a capacitance larger than that of a MEMS microphone chip, and thus, the condenser microphone may have low noise and high performance.

Since a condenser microphone according to the present invention does not employ electrets, the performance of the condenser microphone does not deteriorate after a high-temperature reflow operation, and thus, the condenser microphone may constantly have high quality. Furthermore, the condenser microphone has a capacitance larger than that of a MEMS microphone chip, and thus, the condenser microphone may have low noise and high performance.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

Since the performance of a condenser microphone according to the present invention does not deteriorate after a high-temperature reflow operation, the condenser microphone may constantly have high quality. Furthermore, the condenser microphone has a capacitance larger than that of a MEMS microphone chip, and thus, the condenser microphone may have low noise and high performance. Thus, the condenser microphone according to the present invention may be highly industrially applicable.

1. A condenser microphone assembly with a floating configuration comprising:
a sounding body in which a floating bias voltage is applied between a diaphragm and a rear pole plate facing one another and electrically separated by a small space therebetween, where capacitance changes when the diaphragm vibrates according to sound pressure from an external sound source;
a printed circuit board (PCB) assay having an output terminal and ground terminal formed on an outer surface thereof, connected to an external circuit through the output terminal and ground terminal, having a buffer integrated circuit (IC) mounted on an inner surface thereof to boost an input voltage applied to a voltage pump built into the buffer IC, applying an electrically floating bias voltage to the sounding body, and outputting an amplified electric signal by the buffer IC, of a change in capacitance of the sounding body, through the output terminal and ground terminal; and
a cylindrical case of metal material with one open surface, coated with an insulation material on the inside thereof except for around the end of the open surface, electrically insulated from the sounding body, including the sounding body within a compartment thereof, curling-coupled to the PCB assay, and coupled to the ground terminal to electrically shield the sounding body

2. The condenser microphone assembly of claim 1, wherein the sounding body comprises:
a diaphragm mounted on thing according to an external sound source;
an insulation base, which has a conductive pattern formed on an insulating body, applies a bias voltage of a predetermined polarity to the diaphragm, electrically insulates the diaphragm from the bias voltage having an opposite polarity, and supports internal components of the condenser microphone assembly during a curling operation;
a spacer that is made of a insulation material, is mounted inside the insulation base, and forms fine spaces;
a rear pole plate which faces the diaphragm, wherein the spacer is disposed between the rear pole plate and the diaphragm; and
a conductive base for applying the bias voltage having the other polarity to the rear pole plate.

3. The condenser microphone assembly of claim 2, wherein the spacer and the rear pole plate are integrated as a single body for easy assembly.

4. The condenser microphone assembly of claim 1 or 2, wherein the condenser microphone assembly has a cuboidal shape.

5. The condenser microphone assembly of claim 1 or 2, wherein a sound hole is formed in any one of the case and the PCB assay.
